(19) United States
(12) Patent Application Publication
(10) Pub. No.: US 2010/0182583 A1
(43) Pub. Date: Jul. 22, 2010

(54) EXPOSURE APPARATUS AND DEVICE MANUFACTURING METHOD

(75) Inventors: Naoya Iizuka, Utsunomiya-shi (JP); Fumitaro Masaki, Utsunomiya-shi (JP); Akira Miyake, Nasukarasuyama-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/690,503

(22) Filed: Jan. 20, 2010

(30) Foreign Application Priority Data
Jan. 20, 2009 (JP) 2009-009423

(51) Int. Cl. G03B 27/72; G03B 27/32

(52) U.S. Cl. 355/71; 355/77

(57) ABSTRACT

An exposure apparatus 1 comprises a collecting mirror 104 configured to collect emitted light from plasma 101, an illumination optical system which includes illumination system mirrors 201 to 204 and is configured to illuminate a reticle 301 light collected by the collecting mirror 104 using the second reflective optical element 201 to 204, and a projection optical system configured to project a pattern of the reticle 301 onto a wafer 308. At a predetermined temperature, a first wavelength where a reflectance of light entering the collecting mirror 104 or the illumination system mirrors 201 to 204 at a predetermined angle is peaked is shorter than a second wavelength where a reflectance of light in the projection optical system is peaked.

### BACKGROUND OF THE INVENTION

1. Field of the Invention

The present invention relates to an exposure apparatus and more particularly to an exposure apparatus which transfers a fine pattern using EUV light.

2. Description of the Related Art

Conventionally, as a lithography technology, a reduced projection exposure using ultraviolet rays has been performed. Recently, an exposure apparatus using EUV (Extreme Ultraviolet) light which has a wavelength of around 13.5 nm (hereinafter, referred to as an EUV exposure apparatus) is developed.

The EUV exposure apparatus uses a reflective optical element such as a mirror for its optical system, and a multilayer film which is constituted by alternately laminating two kinds of materials which have optical constants different from each other is formed on a surface of the reflective optical element. The multilayer film is, for example, constituted by alternately laminating pairs of molybdenum (Mo) and silicon (Si) of around 60 layers on a surface of a glass substrate polished so as to be a precise shape. With regard to the thickness of the layers, for example, the thickness of a Mo layer is around 3 nm and the thickness of a Si layer is around 4 nm. The thickness of the addition of the two kinds of material layers is called a film cycle (multilayer period), and the film cycle in the above case is 7 nm.

When EUV light enters the multilayer film mirror, EUV light having a specific wavelength is reflected. When an incident angle, a wavelength of the EUV light, and a film cycle are defined as θ, λ, and d, respectively, only EUV light with a narrow band width centering on λ which satisfies an interference condition is efficiently reflected. The band width in this case is around 0.6 to 1 nm. The interference condition can be approximately represented by the following Bragg's relational expression (1).

2×d×cos θ=λ (1)

The reflectance of the EUV light to be reflected is around 0.7 at a maximum and EUV light which has not been reflected is absorbed in the multilayer film or in the substrate, and most of the energy is changed to heat. Japanese Patent Laid-open No. 2008-508722 discloses a collecting mirror of an EUV light source including a heating apparatus for removing debris. Therefore, the temperature of the collecting mirror rises during exposure.

Thus, when the heat is applied to the multilayer film mirror, the Mo layer and the Si layer are thermally expanded, and the film cycle increases. When the film cycle increases, spectral reflection characteristics of the multilayer film mirror change and the reflectance for the EUV light may be decreased.

NEWRAD 9TH INTERNATIONAL CONFERENCE, 2005, P1, “Improvements in EUV reflectometry at PTB” discloses a temperature rise of a multilayer mirror and a change of spectral reflection characteristics caused by the temperature rise. In this reference, when the temperature of the multilayer film mirror rises by 10 degrees Celsius, a wavelength where a reflectance is peaked (hereinafter, referred to as a “peak wavelength”) increases by around 1 pm.

A lot of heat load are applied to the multilayer film mirror of the EUV exposure apparatus by the irradiation of emitted light from a light source or a heating apparatus as a debris removing device or the like. The multilayer film mirror is heated to thermally expand films constituting the multilayer film mirror and to change the above film cycle. When the film cycle is changed, as represented by the above expression (1), the peak wavelength λ is changed.

Conventionally, the film cycle of the multilayer film mirror has been set so that the peak wavelength is coincident with a center wavelength 13.5 nm of exposure light at the ordinary temperature. Thus, when the peak wavelength changes in accordance with the temperature rise of the mirror during the exposure, the reflectance of the multilayer film mirror at the wavelength of 13.5 nm is decreased and the throughput may be decreased.

In particular, the heat load of the collecting mirror of the light source and the multilayer film mirror of the illumination optical system among the multilayer film mirrors of the EUV exposure apparatus is large. These mirrors are positioned at an upper stream side when viewed from the light source as compared with a mirror of the projection optical system. Therefore, the irradiated light intensity and the absorbed heat of these mirrors are larger than those of the mirror of the projection optical system. The collecting mirror may include a heat apparatus which actively applies heat to a mirror used for removing the debris, and in this case, the collecting mirror is heated up to around 400 degrees Celsius.

On the other hand, the multilayer film mirror of the projection optical system is positioned at a down stream side of the collecting mirror and the illumination optical system, and the temperature rise is small because the incident light intensity is small and the heat load is small. In addition, the multilayer film mirror may be provided with a heat regulating mechanism for keeping the temperature constant to maintain the mirror surface shape. Therefore, the change of the peak wavelength is little generated.

Thus, the peak wavelengths of the collecting mirror of the light source and the illumination system mirror may be changed by the temperature rise. When the peak wavelength changes, the reflectance of the multilayer film mirror at an exposure wavelength is decreased, and the throughput of the exposure apparatus is decreased.

### BRIEF SUMMARY OF THE INVENTION

The present invention provides an exposure apparatus which improves throughput.

An exposure apparatus as one aspect of the present embodiment comprises a first reflective optical element configured to collect emitted light from plasma, an illumination optical system which includes a second reflective optical element and is configured to illuminate a reticle by light collected by the first reflective optical element using the second reflective optical element, and a projection optical system configured to project a pattern of the reticle onto a substrate. At a predetermined temperature, a first wavelength where a reflectance of light entering one of the first reflective optical element and the second reflective optical element at a predetermined angle is peaked is shorter than a second wavelength where a reflectance of light in the projection optical system is peaked.

A device manufacturing method as another aspect of the present invention comprises steps of exposing a substrate using the exposure apparatus and developing the exposed substrate.

Further features and aspects of the present invention will become apparent from the following description of exemplary embodiments with reference to the attached drawings.

### BRIEF DESCRIPTION OF THE DRAWINGS

FIG. 1 is a schematic configuration diagram of an exposure apparatus in the present embodiment.

FIG. 2 is a diagram of reflectance characteristics of a collecting mirror and a projection system mirror used for an exposure apparatus of the present embodiment.

FIG. 3 is a schematic cross-sectional diagram of a collecting mirror in Embodiment 1.

FIG. 4 is a temperature distribution diagram at the time of exposing a collecting mirror in Embodiment 1.

FIG. 5 is a peak wavelength distribution diagram of a collecting mirror in the ordinary temperature in Embodiment 1.

FIG. 6 is a relationship between a radial direction component and a film cycle of a collecting mirror in the ordinary temperature in Embodiment 1.

FIG. 7 is an explanatory diagram of a manufacturing error of a multilayer film mirror in Embodiment 1.

FIG. 8 is a flow of a method of manufacturing a multilayer film mirror in Embodiment 2.

### DETAILED DESCRIPTION OF THE PREFERRED EMBODIMENTS

Exemplary embodiments of the present invention will be described below with reference to the accompanied drawings. In each of the drawings, the same elements will be denoted by the same reference numerals and the duplicate descriptions thereof will be omitted.

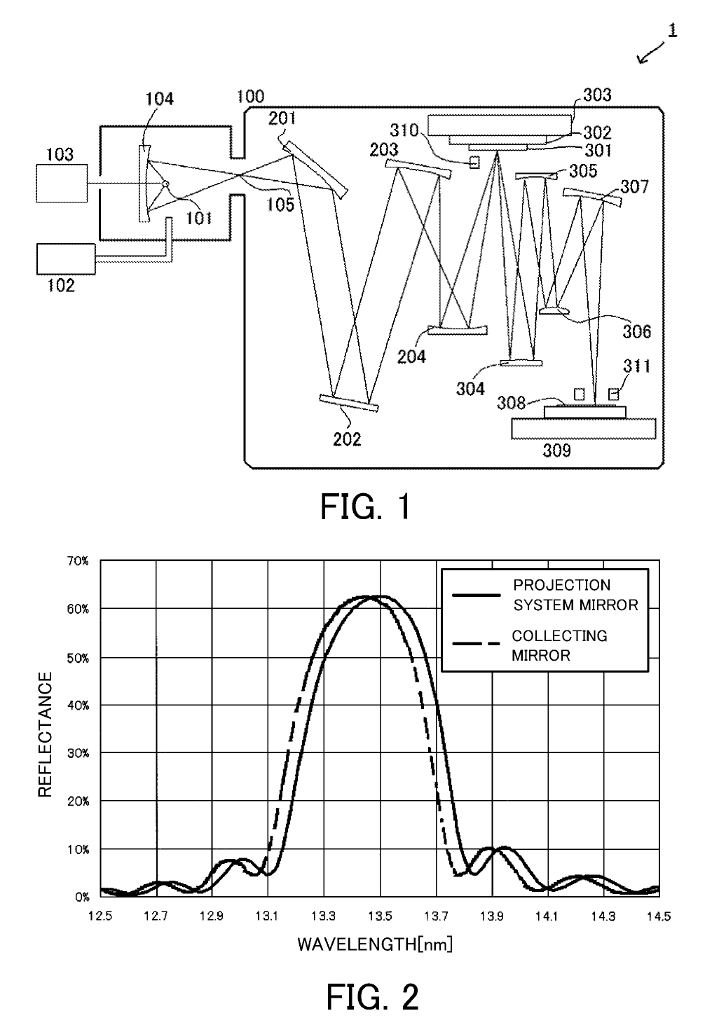

First, an exposure apparatus in an embodiment of the present invention will be described. FIG. 1 is a schematic configuration diagram of the exposure apparatus in the present embodiment. The exposure apparatus 1 of the present embodiment is an EUV exposure apparatus using EUV light (extreme ultraviolet light) that has a central wavelength of 13.5 nm as exposure light. The exposure apparatus 1 is configured to include an EUV light source, an illumination optical system, a reflective reticle, a projection optical system, a reticle stage, a wafer stage, an alignment optical system, a vacuum system, and the like.

As the EUV light source of the present embodiment, a laser plasma light source is used. In the present embodiment, the EUV light source is configured to include plasma 101, a target supplying apparatus 102, an excitation pulse laser 103, and a collecting mirror 104 (a first reflective optical element). The laser plasma light source irradiates high-intensity pulse laser light onto a target material supplied in a vacuum case 100 to generate high-temperature plasma 101 at a luminous point. Emitted light from the plasma 101 is light containing EUV light that has a wavelength of around 13.5 nm, and the exposure apparatus 1 uses the EUV light. A metal thin film, an inert gas, a droplet, or the like is used as the target material. The target material is supplied in the vacuum case 100 by the target supplying apparatus 102 which includes a gas jet or the like. The pulse laser light is outputted from the excitation pulse laser 103 to be irradiated onto the target material.

The emitted light (the EUV light) from the plasma 101 is collected by the collecting mirror 104. The collecting mirror 104 is a multilayer film mirror that has a rotational elliptical surface. The multilayer film mirror is constituted by laminating a plurality of films. The collecting mirror 104 is arranged so that a generation position of the plasma 101 or its vicinity is one of a focal position to collect the emitted light from the plasma 101 at the other focal position to form an image. In FIG. 1, a position of a collecting point 105 corresponds to the other focal position of the collecting mirror 104. The light collected at the collecting point 105 as a secondary light source is diverged, and is guided into the illumination optical system of the exposure apparatus 1 when it is used as an exposure light source. The illumination optical system of the present embodiment is, for example, configured to include an illumination system first mirror 201, an optical integrator 202, an illumination system second mirror 203, and an illumination system third mirror 204. Hereinafter, these mirrors may be collectively referred to as an illumination system mirror (a second reflective optical element).

As described below, as the collecting mirror 104 of the present embodiment, a multilayer film mirror that has a peak wavelength which is shifted from a wavelength (for example 13.5 nm) where light entered at a predetermined angle (exposure light) is peaked to a shorter wavelength side at the ordinary temperature is used. With regard to the illumination mirror, similarly to the collecting mirror 104, a multilayer film mirror having a peak wavelength which is shifted from a peak wavelength of the exposure light to the shorter wavelength side is used. A shift amount of the peak wavelength is adjustable for example by changing a film cycle d as described below. For example, the film cycle d can be decreased in order to shift the peak wavelength to the shorter wavelength side. However, if the multilayer film mirror includes an antioxidizing film, the thickness of the antioxidizing film does not change.

In the present embodiment, the “ordinary temperature” is for example a temperature in the range between 0 and 100 degrees Celsius. The temperature of the collecting mirror 104 or the illumination system mirror increases up to around 200 to 500 degrees Celsius during exposure.

A reticle 301 (an original plate) is a reflective reticle, and a circuit pattern (or an image) to be transferred is formed on the reticle 301. The reticle 301 is supported by a reticle stage 303 using a reticle chuck 302 to be driven. Diffracted light emitted from the reticle 301 is reflected by a projection optical system to be projected onto a wafer 308 (a substrate). In the present embodiment, the projection optical system includes a projection system first mirror 304, a projection system second mirror 305, a projection system third mirror 306, and a projection system fourth mirror 307. These mirrors are multilayer film mirror. Hereinafter, these mirrors may be collectively referred to as a projection system mirror (a third reflective optical element).

The reticle 301 and the wafer 308 are arranged so as to be optically conjugate with each other. Since the exposure apparatus 1 is a step-and-scan type exposure apparatus, the reticle 301 and the wafer 308 are scanned to perform a reduced projection of a pattern on the reticle 301 onto the wafer 308.

The reticle stage 303 supports the reticle 301 and is connected with a movement mechanism (not shown). As the reticle stage 303, any well-known structure can be applied. The movement mechanism (not shown) is constituted by a linear motor or the like, and can drive the reticle stage 303 at least in an x direction to move the reticle 301. The exposure apparatus 1 synchronously scans the reticle 301 and the wafer 308. In the embodiment, a scanning direction in a plane of the reticle 301 or the wafer 308, a direction perpendicular to the scanning direction in the plane, and a direction perpendicular to surfaces of the reticle 301 and the wafer 308 are x, y, and z directions, respectively.

The projection optical system of the exposure apparatus 1 performs a reduced projection of the pattern on the surface of the reticle 301 onto the wafer 308 arranged at an image plane using the plurality of projection system mirrors. The number of the plurality of projection system mirrors is around four to eight. In order to realize a wide exposure area with a small number of the mirrors, only a thin arc-shaped area (a ring field) positioned at a predetermined distance from an optical axis is used, and the reticle 301 and the wafer 308 are simultaneously scanned to transfer a wide area. The numerical aperture (NA) of the projection optical system is around 0.25 to 0.4.

In the present embodiment, as the plurality of projection system mirrors provided in the projection optical system, a multilayer film mirror having optical characteristics that a peak wavelength is a wavelength 13.5 nm of the exposure light (a second wavelength) during the exposure is used. Such optical characteristics have only to be satisfied as a whole of the plurality of projection system mirrors included in the projection optical system. For example, a single projection system mirror may have optical characteristics that the peak wavelength is a wavelength shifted from the wavelength of 13.5 nm considering aberrations or the like. However, even in such a case, a whole of the projection optical system has optical characteristics that the peak wavelength is a wavelength 13.5 nm of the exposure light.

In the present embodiment, the wafer 308 is a semiconductor wafer. The present embodiment is not limited to this, but for example a liquid crystal substrate or other objects to be processed may be applied. Photoresist is applied onto the wafer 308.

The wafer stage 309, for example moves the wafer 308 in xyz directions using a linear motor. The reticle 301 and the wafer 308 are synchronously scanned each other. The positions of the reticle stage 303 and the wafer stage 309 are monitored by a laser interferometer or the like so that both are driven at a constant velocity ratio.

An alignment detector 310 measures a position relation between the reticle 301 and the optical axis of the projection optical system and a position relation between the wafer 308 and the optical axis of the projection optical system. The alignment detector 310 sets positions and angles of the reticle stage 303 and the wafer stage 309 so that a projection image of the reticle 301 is coincident with a predetermined position of the wafer 308.

A focus position detector 311 measures a focus position in a z direction at the surface of the wafer 308 and controls the position and the angle of the wafer stage 309 to always hold the surface of the wafer 308 at an imaging position of the projection optical system during the exposure.

The EUV light emitted from the illumination optical system illuminates the reticle 301 during the exposure to form an image of the pattern on the surface of the reticle 301 onto the surface of the wafer 308 via the projection optical system. In the present embodiment, the image plane is an arc-shaped (a ring-shaped) image plane, and the reticle 301 and the wafer 308 are scanned at a velocity ratio of a reduced magnification ratio to expose the whole surface of the reticle 301.

The illumination optical system and the projection optical system of the exposure apparatus 1 reflect the EUV light with high reflectance and have a superior imaging performance. Thus, the exposure apparatus 1 can economically provide a high-quality device (a semiconductor device, an LCD device, an image pickup device (a CCD or the like), a thin-film magnetic head, or the like) with high throughput.

Next, a reflectance of the multilayer film mirror used for the exposure apparatus of the present embodiment will be described. FIG. 2 is one example of reflectance characteristics of the multilayer film mirror used for the exposure apparatus 1 of the present embodiment. In FIG. 2, a solid line shows reflectance characteristics of the projection system mirror at the ordinary temperature, and a dotted line shows reflectance characteristics of the collecting mirror 104 at the ordinary temperature.

As shown in FIG. 2, the reflectance of the projection system mirror used for the exposure apparatus 1 of the present embodiment shows a peak at the wavelength of 13.5 nm at the ordinary temperature (at a predetermined temperature). In other words, the wavelength (the second wavelength) where the reflectance of the light entering the projection system mirror (the reflectance of the whole projection optical system) is peaked is 13.5 nm. On the other hand, the reflectance of the collecting mirror 104, for example, shows a peak at a wavelength of 13.45 nm shorter than the wavelength of 13.5 nm. In other words, the wavelength (the first wavelength) where the reflectance of the light entering the collecting mirror 104 at a predetermined angle is peaked is, for example 13.45 nm.

The collecting mirror 104 of the present embodiment includes a heating apparatus for removing debris. Such a heating apparatus holds the temperature of the collecting mirror 104 to for example 400 degrees Celsius during the exposure to melt and gasify the debris deposited on the surface of the collecting mirror 104.

The collecting mirror 104 is a multilayer film mirror and is formed by using a substrate made of a rigid and high hardness material with a small coefficient of thermal expansion such as a low-expansion glass or a silicon carbide. The collecting mirror 104 has a predetermined reflective surface shape formed by grinding and polishing the substrate, and is formed by depositing the multilayer film such as Mo/Si on the reflective surface. As described above, when the heat load is applied, the collecting mirror 104 changes its film thickness (increases its film thickness) by heat expansion, and a wavelength where the reflectance of incident light is peaked is shifted to a long wavelength side. Therefore, the peak wavelength at the ordinary temperature of the collecting mirror 104 in the present embodiment is previously set at the short wavelength side considering the shift to the long wavelength side of the peak wavelength in increasing the temperature.

Thus, at the ordinary temperature, the first wavelength where the reflectance of the light entering the collecting mirror 104 at a predetermined angle is peaked is shorter than the second wavelength where the reflectance of the light in the projection optical system is peaked. The shift amount of the wavelength is set in accordance with a difference between a temperature (a first temperature) that the collecting mirror reaches during the exposure and the ordinary temperature (a second temperature). In other words, the first wavelength in a case where the collecting mirror 104 is at the first temperature is set so as to be coincident with the second wavelength in a case where the projection optical system is at the second temperature lower than the first temperature. If necessary, also for the illumination system mirror, a peak wavelength at the ordinary temperature is set by the same method as that of the collecting mirror 104.

The change of the film thickness described in the present embodiment is a reversible change without film structural changes. Generally, as a factor of the reflectance reduction caused by the temperature rise of the multilayer film mirror, in addition to the shift of the peak wavelength by the thermal expansion, a change of the multilayer film structure is known. When Mo and Si are mixed by diffusion at an interface of the multilayer film at a high temperature, the change of the multilayer film structure causes a reduction of the reflectance. Such a film structural change is an irreversible change, and in order to solve the problem, for example a method of inserting a Si oxide layer with superior heat resistance is known. The present embodiment is intended for a shift of the peak wavelength caused by a heat expansion without the film structural change.

### Embodiment 1

Next, Embodiment 1 of the present invention will be described. The collecting mirror 104 of the present embodiment is, previously considering the temperature rise during the exposure, set so that a peak wavelength of the reflected light at the ordinary temperature is shorter than the peak wavelength 13.5 nm of the wavelength which is projected onto the wafer 308. Specifically, a value of the peak wavelength is set considering a shift of the peak wavelength so that the peak wavelength of the reflected light on the collecting mirror 104 coincides with the center wavelength 13.5 nm of the exposure light at the temperature that the collecting mirror 104 reaches during the exposure.

According to the above NEWRAD 9TH INTERNATIONAL CONFERENCE, 2005, P1, “Improvements in EUV reflectometry at PTB”, the peak wavelength of the reflected light increases around 1 pm as the temperature of the multilayer film mirror rises by 10 degrees Celsius. For example, when the temperature of the collecting mirror rises by 400 degrees Celsius during the exposure, the peak wavelength increase around 40 pm as compared with the ordinary temperature. In this case, the collecting mirror is preferably set so that the peak wavelength is 13.46 which is shorter than 13.5 nm by 40 pm at the ordinary temperature.

In the present embodiment, similarly to the case of the collecting mirror 104, also for the multilayer film mirror of the illumination optical system, the peak wavelength at the ordinary temperature is previously set to the short wavelength side as compared with the wavelength of 13.5 nm so that the peak wavelength is 13.5 nm during the exposure (when the temperature rises). In this case, the shift amount of the peak wavelength is independently set for the temperature that each multilayer film mirror reaches during the exposure.

With regard to the multilayer film mirror of the projection optical system, the heat load is small during the exposure and the heat for the purpose of removing the debris is not performed. Therefore, the shift amount of the peak wavelength is small. Accordingly, with regard to the multilayer film mirror of the projection optical system, the setting considering the shift of the peak wavelength caused by the heat load is not performed. In other words, all multilayer film mirrors in the projection optical system are set so that the peak wavelength is 13.5 nm at the ordinary temperature. If aberrations need to be considered, all of the multilayer film mirrors in the projection optical system do not have to be set so that the peak wavelength of the reflectance is 13.5 nm. However, even in this case, the peak wavelength of the whole reflectance of all the multilayer film mirrors constituting the projection optical system is set to 13.5 nm during the exposure.

As seen in the above Bragg's relational expression, the reflectance of the multilayer film mirror differs in accordance with the angle of the incident light. The reflectance of all of the multilayer film mirrors in the present embodiment is a reflectance in a condition where the angle of the EUV incident light is a real angle of the EUV incident light in the EUV exposure apparatus, and the peak wavelength of all of the multilayer film mirrors is 13.5 nm during the exposure.

As described above, the EUV light illuminance in the plane of the multilayer film mirror used for the exposure apparatus 1 is not uniform and a temperature irregularity is generated in the plane of the multilayer film mirror during the exposure. The collecting mirror 104 and the multilayer film mirror (the illumination system mirror) of the illumination optical system in the present embodiment have peak wavelength distributions which correspond to in-plane temperature distributions.

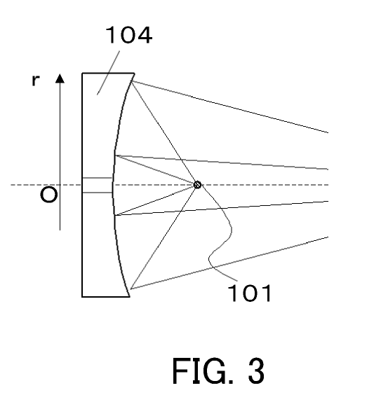

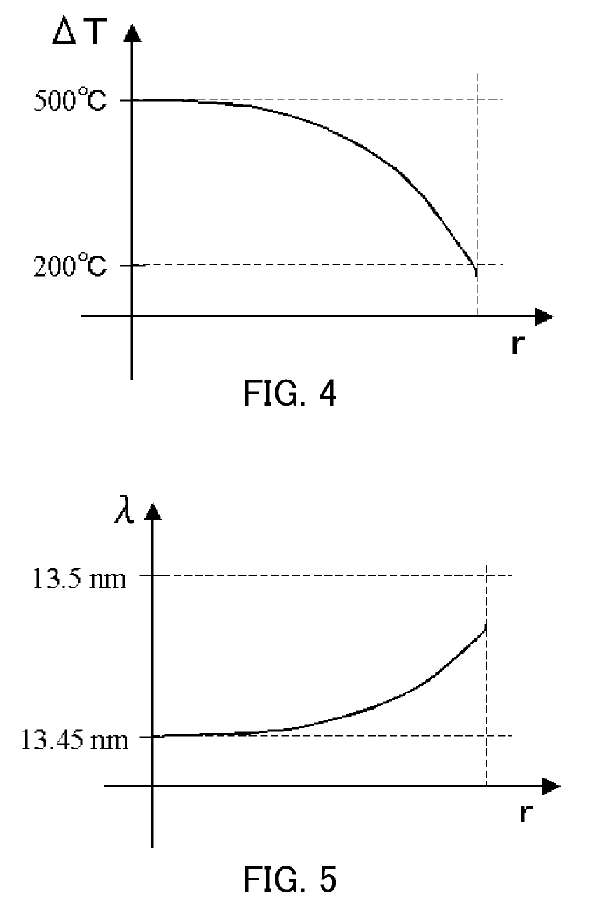

Next, referring to FIGS. 3 to 6, a peak wavelength distribution which corresponds to an in-plane temperature distribution of the collecting mirror 104 of the present embodiment will be described. FIG. 3 is a schematic cross-sectional diagram of the collecting mirror 104 in the present embodiment. As shown in FIG. 3, a radial direction component of the collecting mirror 104 is defined as r, and the maximum temperature in the plane of the collecting mirror 104 during the exposure is regarded as 500 degrees Celsius. In this case, the temperature distribution of the collecting mirror 104 during the exposure is shown in FIG. 4. As shown in FIG. 4, the temperature in the vicinity of the center O of the collecting mirror 104 is relatively high (the temperature rise is large) because the distance from the plasma 101 is short and the irradiance is large. On the other hand, as the distance from the center O of the collecting mirror 104 is larger to be closer to an edge part, the temperature rise of the collecting mirror 104 is smaller because the distance from the plasma 101 is larger and the irradiance is smaller.

Therefore, the collecting mirror 104 of the present embodiment has a peak wavelength distribution shown in FIG. 5 at the ordinary temperature when a temperature distribution shown in FIG. 4 during the exposure is obtained. In other words, the peak wavelength at the ordinary temperature is shifted to the short wavelength side by 50 pm in the vicinity of the center O of the mirror whose risen temperature is 500 degrees Celsius so as to correspond to the in-plane risen temperature of the collecting mirror 104. In the vicinity of the edge part of the mirror whose risen temperature is 200 degrees Celsius, the peak wavelength at the ordinary temperature is shifted to the short wavelength side by 20 pm.

As shown in FIG. 3, angles (incident angles) of lights entering the mirror surface in the vicinity of the center and the edge part of the collecting mirror 104 are different from each other. The incident angle in the vicinity of the center of the collecting mirror 104 is comparatively small, and the incident angle in the vicinity of the edge part is comparatively large. Considering the Bragg's relational expression, the peak wavelength λ changes in accordance with the change of the incident angle θ. Therefore, in order to correct the change of the incident angle θ, the film cycle d needs to be changed. Specifically, the film is formed so that the film cycle d is comparatively short in the vicinity of the center of the collecting mirror 104 and the film cycle d is longer as the film is closer to the edge part of the collecting mirror 104.

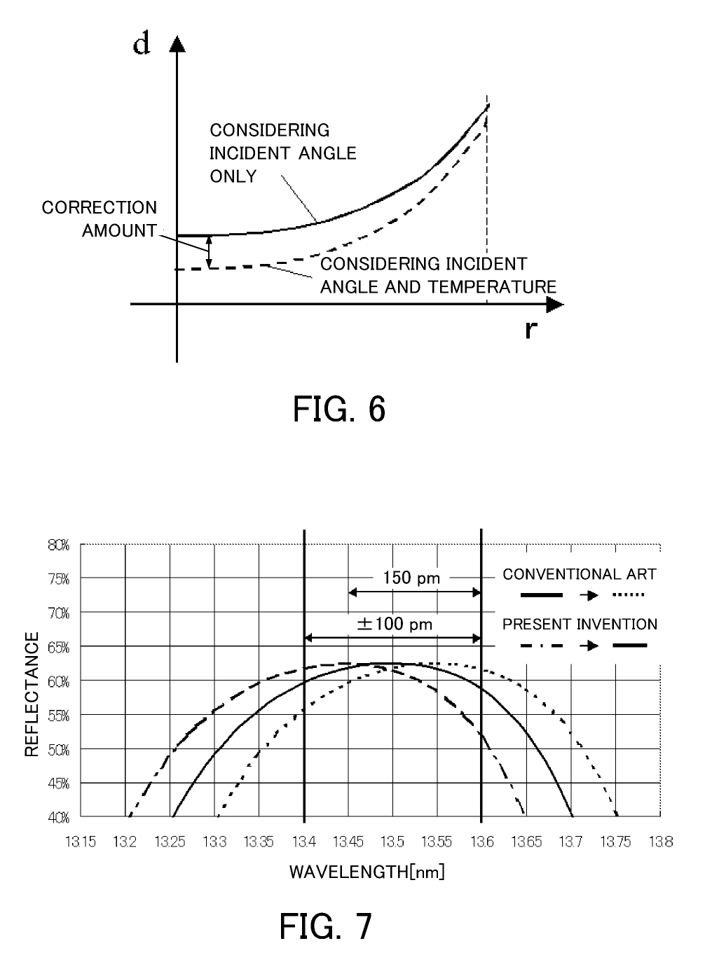

FIG. 6 is a relationship diagram between a radial direction component r (a position in a radial direction) of the collecting mirror 104 and a film cycle d at the ordinary temperature. A curve represented by a solid line in FIG. 6 is a relationship diagram in a case where the temperature rise of the collecting mirror 104 is not considered. On the other hand, a curve represented by a dashed line in FIG. 6 is a relationship diagram in a case where the temperature rise is considered. In other words, the dashed line is obtained by correcting the film cycle d considering the temperature change (temperature rise) during the exposure in addition to the correction of the film cycle d required by the difference of incident angles θ. As represented by the dashed line in FIG. 6, in the vicinity of the center of the collecting mirror 104, a correction amount of the film cycle d by the temperature change is large. On the other hand, in the vicinity of the edge part of the collecting mirror 104, a correction amount of the film cycle d is small. Thus, in accordance with the in-plane temperature distribution of the collecting mirror 104 during the exposure, thicknesses of a plurality of films change in the radial direction of the collecting mirror 104.

In the present embodiment, the peak wavelength distribution in the plane of the collecting mirror 104 has been described. However, the present embodiment is not limited to this. For example, the multilayer film mirror (the illumination system mirror) of the illumination optical system is arranged so as to be close to the EUV light source. Therefore, the illumination system mirror may also be influenced by the temperature rise. In this case, similarly to the collecting mirror 104, the illumination system mirror is also corrected. In other words, if necessary, the illumination system mirror is also configured so as to have a peak wavelength distribution which corresponds to the in-plane temperature distribution during the exposure.

Next, referring to FIG. 7, a peak wavelength error in manufacturing the multilayer film mirror will be described. A permissible range of the peak wavelength error of the multilayer film mirror is set to for example ±100 pm, and the mirror temperature rise during the exposure is set to for example 500 degrees Celsius. In this case, the peak wavelength of the multilayer film mirror is shifted by +50 pm by the temperature rise during the exposure. Therefore, conventionally, the permissible range of the substantial wavelength error was 150 pm. However, as described in the embodiment, previously considering the shift by the temperature rise of the peak wavelength, the film is formed by shifting the peak wavelength to the short wavelength side by 50 pm to be able to set the permissible range of the peak wavelength error to 200 pm. In other words, the error range of the peak wavelength in manufacturing the multilayer film mirror can be widened by 50 pm. In this case, the manufacturing error of the multilayer film mirror improves 33% as compared with the conventional case.

All of the multilayer film mirrors mounted on the exposure apparatus 1 of the present embodiment have a peak wavelength of 13.5 nm at a real incident angle θ during the exposure, and the error of the peak wavelength in this case is for example around ±50 pm. Considering the throughput of the exposure apparatus 1, the reduction of the transmittance of the optical system needs to be suppressed as much as possible. In the embodiment, as a permissible range of the reflectance reduction, for example the reflectance reduction per one multilayer film mirror caused by the shift of the peak wavelength is set to equal to or less than 1%. In this case, referring to the reflectance characteristics of the multilayer film mirror shown in FIG. 2, the peak wavelength of the reflectance needs to be suppressed in a range of around ±50 pm with reference to 13.5 nm as a center. Therefore, all of the multilayer film mirrors mounted on the exposure apparatus 1 of the present embodiment have an error ±50 pm of the peak wavelength of the reflectance.

The present embodiment has described the center wavelength 13.5 nm of the exposure light, but is not limited to this, and the center wavelength of the exposure light may also be other than the value of 13.5 nm. For example, when the center wavelength of the exposure light of the exposure apparatus is 13.4 nm, the peak wavelength of the projection optical system is set to 13.4 nm at the ordinary temperature. In accordance with that, the peak wavelength of the collecting mirror is set to 13.35 nm for example in a case where the mirror temperature rises by 500 degrees Celsius during the exposure.

### Embodiment 2

Next, Embodiment 2 of the present invention will be described. In the exposure apparatus of Embodiment 1, the relationship between the risen temperature of the multilayer film mirror and the shift amount of the peak wavelength in accordance with that has been set so that the shift amount changes by +1 pm if the temperature changes by +10 degrees Celsius. However, the relationship between the risen temperature of the mirror and the shift amount of the peak wavelength changes in accordance with the film forming process, the material, or the like. Therefore, in order to precisely obtain the relationship, it is effective that the relationship is obtained by performing a real measurement.

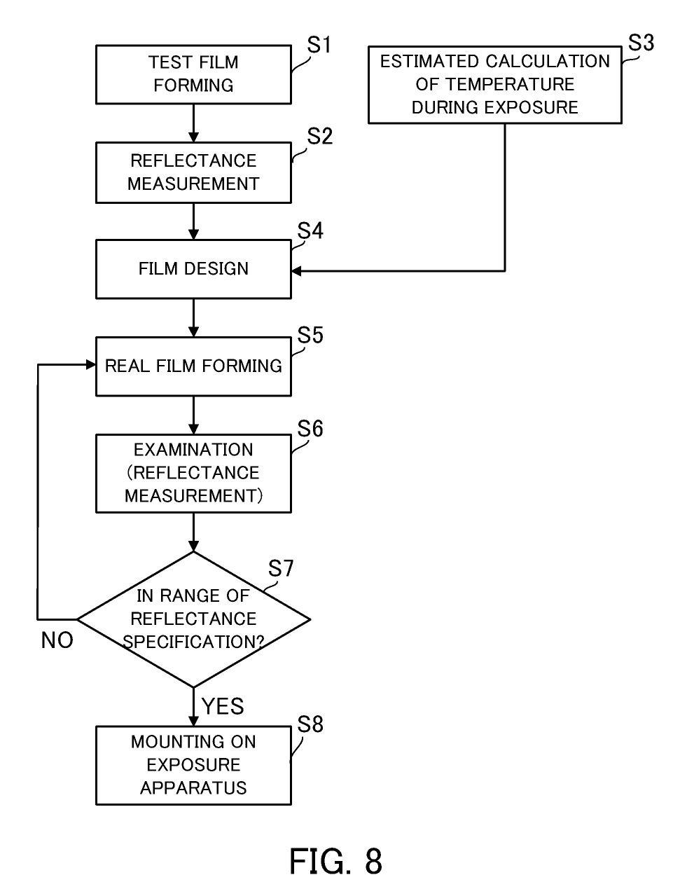

Hereinafter, referring to FIG. 8, a method of manufacturing the multilayer film mirror which is mounted on the exposure apparatus of the present embodiment will be described. FIG. 8 is a flow of the method of manufacturing the multilayer film mirror in the present embodiment.

First, using a film forming apparatus (coating equipment), a test mirror having the same film structure as that of the multilayer film mirror which is really mounted on the exposure apparatus is formed (step S1). Next, the test mirror is heated, for example up to 100 to 200 degrees Celsius, and the change of the reflectance caused by the temperature change at that time is measured by using a measurement apparatus (step S2). The relationship between the temperature rise of the multilayer film mirror and a shift amount of the peak wavelength caused by the temperature rise can be obtained by the reflectance measurement. In addition, an exposure time achieving temperature of the multilayer film mirror is obtained by a calculation (step S3).

Next, based on the exposure time achieving temperature of the multilayer film mirror obtained by the calculation, a film cycle length corresponding to the shift amount of the peak wavelength is set (step S4), and the real multilayer film mirror which is actually used is formed (step S5). Then, whether or not the real multilayer film mirror is formed as a set cycle length is examined by measuring the reflectance of the real multilayer film mirror using a measurement apparatus (step S6).

Next, whether or not the reflectance of the real multilayer film mirror is in a range of a specification is determined (step S7). When the reflectance is not in the range of the specification, the flow returns to step S5 and again the multilayer film mirror is formed. On the other hand, when the reflectance is in the range of the specification, this multilayer film mirror is mounted on an exposure apparatus (step S8). The criteria of the examination are set so that for example an error of the peak wavelength is in ±50 pm of a designed value.

According to the present embodiment, the relationship between the temperature rise of the multilayer film mirror and the shift amount of the peak wavelength caused by the temperature rise can be obtained by an actual measurement. Therefore, the peak wavelength of the reflectance can be exactly corrected.

A device (a semiconductor integrated circuit device, a liquid crystal display device, or the like) is manufactured by a process of exposing a substrate (a wafer, a glass plate, or the like) which is coated by a photosensitizing agent using the exposure apparatus in any one of the above embodiments, a process of developing the substrate, and other well-known processes. According to the device manufacturing method, a high-quality device as compared with a conventional device is able to be manufactured. Thus, the device manufacturing method using the exposure apparatus also constitutes one aspect of the present invention.

According to each of the above embodiments, the decrease of the reflectance caused by the temperature rise of the multilayer film layer mounted on the exposure apparatus during the exposure is suppressed, and the decrease of the throughput caused by the temperature rise can be suppressed. In addition, the error of the multilayer film mirror at the time of manufacturing the multilayer film mirror can be eased. Therefore, according to the above embodiment, the exposure apparatus and the device manufacturing method which improve the throughput can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-009423, filed on Jan. 20, 2009, which is hereby incorporated by reference herein in its entirety.

What is claimed is:

1. An exposure apparatus comprising:
a first reflective optical element configured to collect emitted light from plasma;
an illumination optical system which includes a second reflective optical element and is configured to illuminate a reticle by light collected by the first reflective optical element using the second reflective optical element; and
a projection optical system configured to project a pattern of the reticle onto a substrate,
wherein, at a predetermined temperature, a first wavelength where a reflectance of light entering one of the first reflective optical element and the second reflective optical element at a predetermined angle is peaked is shorter than a second wavelength where a reflectance of light in the projection optical system is peaked.

2. An exposure apparatus according to claim 1,
wherein the first wavelength in a case where one of the first reflective optical element and the second reflective optical element is at a first temperature is coincident with the second wavelength in a case where the projection optical system is at a second temperature lower than the first temperature.

3. An exposure apparatus according to claim 1,
wherein one of the first reflective optical element and the second reflective optical element is a multilayer film mirror constituted by laminating a plurality of films, and
wherein thickness of the plurality of films changes in accordance with an in-plane temperature distribution of one of the first reflective optical element and the second reflective optical element during exposure.

4. A device manufacturing method comprising the steps of:
exposing a substrate using an exposure apparatus; and
developing the exposed substrate,
wherein the exposure apparatus comprises:
a first reflective optical element configured to collect emitted light from plasma;
an illumination optical system which includes a second reflective optical element and is configured to illuminate a reticle by light collected by the first reflective optical element using the second reflective optical element; and
a projection optical system configured to project a pattern of the reticle onto a substrate, and
wherein, at a predetermined temperature, a first wavelength where a reflectance of light entering one of the first reflective optical element and the second reflective optical element at a predetermined angle is peaked is shorter than a second wavelength where a reflectance of light in the projection optical system is peaked.
